(19) United States
(12) Patent Application Publication
(10) Pub. No.: US 2024/0308411 A1
(43) Pub. Date: Sep. 19, 2024

(54) MAGNETIC ANCHORING STRAP SYSTEM

(71) Applicant: JORGE FIDALGO, MONTEVIDEO (UY)

(72) Inventor: JORGE FIDALGO, MONTEVIDEO (UY)

(21) Appl. No.: 18/436,785

(22) Filed: Feb. 8, 2024

Related U.S. Application Data
(60) Provisional application No. 63/490,761, filed on Mar. 16, 2023.

(51) Int. Cl. B60P 7/08

(52) U.S. Cl. CPC B60P 7/0823

(57) ABSTRACT

A Magnetic Anchoring Strap System. The Magnetic Anchoring Strap System improves the way in which a roof rack or luggage is secured to the roof of a vehicle, offering the most practical and simple way: providing means for a strap, attached to a roof rack or a load to be attached to a door frame of the vehicle, in a way that avoids the drawbacks of the previous techniques. In accordance with the teachings of the present invention, a magnetic anchoring strap system is provided which can be attached to a load strap that is set to be mounted directly to the door frame. The magnetic anchoring strap system can remain in position, in the door frame, regardless of the degree of tension on the load strap or the degree of pull on the magnetic anchor, as well as when the load strap is loose.

### CROSS REFERENCE

This application is a continuation of U.S. Provisional Patent Application Ser. No. 63/490,761 entitled “MAGNETIC ANCHORAGE FOR A VEHICLE FRAME TO SECURE LUGGAGE RACKS AND CARGO”, filed on Mar. 3, 2023, which is incorporated by reference herein in by its entirety.

### BACKGROUND OF THE INVENTION

The present invention is directed to a magnetic anchoring strap system that allows a load strap linked to a vehicle roof rack to be attached to a vehicle door frame for securing the roof rack when its strap is fastened.

The magnetic anchoring strap system can be installed at any point of the top of the door frame. The magnetic anchoring strap system of the invention can remain in position at the top of the door frame regardless of the degree of tension on the load strap or the degree of pull on the anchorage, as well as when the load strap is loose. In addition, it does not damage the door seal neither does it interfere with its sealing function or with the door closing action.

Vehicle roof racks are well known. These typically include bars, baskets, general purpose shelves, rigid cabinets, or flexible cabinets, and a variety of special purpose carriers designed for specific types of equipment such as bicycles, boats, skis, etc. A roof rack can be considered interchangeably as a load or a load carrier. It should also be understood that these terms include baggage not specifically designed to be carried on the roof of a vehicle, such as suitcases, bags, and cardboard boxes.

All roof racks and roof cargo have one fundamental common need: to be firmly secured to the vehicle body so that they remain in place during vehicle movement.

Generally, said fastening is done by means of (a) clamps installed in the roof racks that are mounted on the fastening rails, which some vehicles carry on their roofs, or (b) clamps that the roof racks carry for securing on the upper part of the door frames. Another method used to secure luggage or cargo is by (c) straps crossing the door frames transversely (d) or straps anchored to the door frames.

The subjection of the roof rack or load can be classified in general terms in these four types and we will detail the inconveniences that arise when the user does not acquire the roof rack that was manufactured specifically for the model of his vehicle, which are generally much more expensive and are usually scarce in the market, especially in vehicle models that are several years old, and are no longer produced, or new vehicles that are fresh on the market, and have not had a roof rack designed for yet. Vehicles which have permanent rails on the sides of the roof are the most practical because they mark where the roof rack anchor must go, but it is necessary to know about design to search the market for the best suited anchorage. Knowledge and proper guidance are required for the load carrier to stay firm. The roof racks (b) with a rigid structure which must be installed on the roof of the vehicle by anchoring in the door frames, are usually very varied and are offered as universal. They come with several anchorages making it possible to try which one best suits each vehicle, but on many occasions none fit, causing the roof rack to move, loosening the cargo or even detaching it from the roof. Installation usually requires time and patience. The straps (c) that cross the door frames have several drawbacks, interfering with the side airbags, bothering the occupants by causing friction against their heads, and by pushing the door seals against the roof frame, they render their function ineffective and get the interior of the vehicle wet on rainy days. The straps (d) which are installed in the door frames demand the removal of the weather stripping and in some vehicles tools are necessary. Both to install or remove the anchorage, it is necessary to disassemble and re-assemble the weather stripping, weakening the structure and deforming the rubber seal, compromising the function for which it was installed.

Therefore, there is a need to have a magnetic anchoring strap system for attaching roof rack load straps to the door frame of a vehicle.

### SUMMARY OF THE INVENTION

The main objective of the present invention is to improve the way in which a roof rack or luggage is secured to the roof of a vehicle, offering the most practical and simple way: providing means for a strap, attached to a roof rack or a load to be attached to a door frame of the vehicle, in a way that avoids the drawbacks of the previous techniques. In accordance with the teachings of the present invention, a magnetic anchoring strap system is provided which can be attached to a load strap that is set to be mounted directly to the door frame. The magnetic anchoring strap system can remain in position, in the door frame, regardless of the degree of tension on the load strap or the degree of pull on the magnetic anchor, as well as when the load strap is loose.

More specifically, in accordance with the present invention, a magnetic anchoring strap system is provided to allow for a load strap, attached to a roof rack, in a vehicle, to be anchored in the door frame of the vehicle to secure the load. The magnetic anchoring strap system is designed so that, by means of a strap, it fastens the roof rack to the door frame of the vehicle. An important detail to highlight is that, when the door is closed, it acts as a security lock, preventing the magnetic anchoring strap system from detaching from the place where it was installed.

The magnetic anchoring strap system by remaining encapsulated between the door frame and the frame of the chassis, when the door is closed, in addition to being used to secure roof racks and loads, can also be used as a security method, linking what is transported in the roof to the magnetic anchoring strap system by means of a strap, thus preventing the load from separating from the vehicle. If it were accidentally detached from the roof, it would avoid third parties from being injured. It can also be used as a good anti-theft system when the occupants are not in the vehicle, leaving what is transported on the roof attached to the vehicle by means of the strap and the magnetic anchoring strap system. In either of the last two cases mentioned, the strap has to be secured but it does not need to be under tension.

In some embodiments the magnetic anchoring strap system was designed so that the magnetic element is attached to the inside of the vehicle door frame, and in others it is designed to be installed on the vehicle body frame with the magnetic element attached to the roof of the vehicle. In some embodiments, the magnetic anchoring strap system was made with a metallic structure to link the magnetic element, in others with rubber or different polymer covers. In some embodiments, natural or synthetic fiber straps were used to attach the magnetic anchoring strap system to the roof rack or luggage carrier, as well as allowing for metal, rubber, plastic or a combination of different elements to be used to fulfill the same purpose. The magnetic anchoring strap system has been made with a slot for the strap to pass through, or with a ring, or with clamping bolts, or by wrapping the magnetic element in the clamping element. A feature of the magnetic anchoring strap system is that it remains attached to the door frame even when the load strap is loose or absent. Other features of the magnetic anchoring strap system are that, while it is anchored in the door frame, it essentially does not interfere with the closing of the corresponding vehicle door. There is no need to dismount anything from the vehicle, and it does not damage the sealant nor interfere with its sealing function.

An object of the present invention is to provide a magnetic anchoring strap system that will allow a luggage rack to be secured to a vehicle roof.

Another object of the present invention is to provide a magnetic anchoring strap system that can prevent accidents and theft.

Yet another object of the invention is to a provide magnetic anchoring strap system that does not interfere with the closing of the vehicle doors when used.

### BRIEF DESCRIPTION OF THE DRAWINGS

These and other features, aspects, and advantages of the present invention will become better understood with regards to the following description, appended claims, and drawings where:

FIG. 1 is an illustration of the perspective view of the frontal top of the magnetic anchoring strap system (as detailed: magnet 110, mount 100, strap 130, receiver 120);

FIG. 2 is the front view of the magnetic anchoring strap system of FIG. 1 (as detailed: magnet 110, mount 100, receiver 120);

FIG. 3 is the side view of the magnetic anchoring strap system of FIG. 1 (as detailed: mount 100, magnet 110);

FIG. 4 is an illustration of the top frontal perspective view of the magnetic anchoring strap system that fulfills the same function but developed in a different way (as detailed: magnet 210, mount 200, receiver 220);

FIG. 5 is the front view of the magnetic anchoring strap system of FIG. 4 (as detailed: magnet 210, receiver 220, mount 200);

FIG. 6 is the side view of the magnetic anchoring strap system of FIG. 4 (as detailed: metallic mount 200, receiver 220);

FIG. 7 is an illustration in top frontal perspective view of the magnetic anchoring strap system also made in a different way (as detailed: magnet 310, strap 330, mount 300, pin 322, and receiver 320);

FIG. 8 is the front view of the magnetic anchoring strap system of FIG. 7 (as detailed: magnet 310, mount 300, strap 330);

FIG. 9 is the side view of the magnetic anchoring strap system of FIG. 7 (as detailed: magnet 310, mount 300, pin 322);

FIG. 10 is an illustration of the top frontal perspective view of the magnetic anchoring strap system, but instead of the magnetic attaching to the vehicle frame, it attaches to the roof of the vehicle door frame (as detailed: magnet 410, mount 400, receiver 420, strap 430, and ledge 400c, the ledge prevents the magnetic anchoring strap system from detaching, when the doors are closed);

FIG. 11 is the front view of the magnetic anchoring strap system of FIG. 10 (as detailed: magnet 410, receiver 420, mount 400);

FIG. 12 is the side view of the magnetic anchoring strap system of FIG. 10 (as detailed: metallic structure 400, magnetic element 410, safety elevation to anchor with the door frame, and prevent the magnetic anchoring strap system from detaching, when the door is closed 440c.

The magnetic anchoring strap system is extremely simple and practical to use. The following illustrations detail how to proceed to install and remove it from the door of the vehicle (FIG. 13 it is installed and FIG. 18 it is withdrawn) and how it is linked to one of the roof rack models:

FIG. 13 shows how the magnetic anchoring strap system is attached to the upper part of the vehicle door frame when the vehicle door is open;

FIG. 14 shows how the magnetic anchoring strap system is attached to the vehicle when the door is closed, in this figure a roof rack is secured onto the roof of the vehicle;

FIG. 15 illustrates how the strap of the magnetic anchoring strap system is attached to the cam buckle of the roof rack, so that by adjusting it the necessary tension is achieved, to guarantee the stability and rigidity of the roof rack;

FIG. 16 shows how the excess of the strap of the magnetic anchoring strap system is covered by a roof rack cover;

FIG. 17 shows how the strap is removed from the roof rack of the vehicle;

FIG. 18 shows how the magnetic anchoring strap system is gently removed from the door frame of the vehicle;

FIG. 19 shows an illustration of the cross section of a door frame 202, and a body frame 203 of a vehicle, which has a magnetic anchoring strap system 200 (represents the magnetic anchoring strap system of FIG. 04) attached to the door frame of the vehicle 203, and attached to the luggage or roof rack by the strap 230, also detailed in the illustration is the space between the two frames where the strap passes 206, the cavity 205 between the door frame 202 and the frame of the vehicle 203, the roof of the vehicle 204 and the vehicle frame rubber seal 207;

FIG. 20 is the illustration of the cross section of a door frame 202, and a body frame 203 of a vehicle, which has a magnetic anchoring strap system 300 (represents the magnetic anchoring strap system of FIG. 07) attached to the door frame the vehicle 203, in this case it is attached to another section of the vehicle frame and attached to a luggage or a roof rack by a strap 330, also detailed in the illustration is the space 206 between the two frames wherein the strap 330 passes, the cavity 205 between the door frame 202 and the vehicle frame 203, the roof of the vehicle 204 and the vehicle frame rubber seal 207;

FIG. 21 is an illustration of the cross section of a door frame 202, and a body frame 203 of a vehicle, which has a magnetic anchoring strap system 400 (represents the magnetic anchorage of FIG. 10) attached to the door frame of the vehicle 203 and the roof frame of the vehicle 204, in this example the magnet 410 is placed on the roof of the roof frame of the vehicle 204, the magnetic anchoring strap system is attached to luggage or roof racks by means of a strap 430, also shows the ledge 400c of the mount 400 of the magnetic anchoring strap system, the space between the two frames where the magnetic anchoring strap system passes 206, the cavity 205 between the door frame 202 and the vehicle frame 203, the vehicle roof 204 and the rubber seal of the vehicle frame 207;

FIG. 22 shows a roof bag attached to the door frame by straps linked to the magnetic anchoring strap system;

FIG. 23 shows how roof bars are fastened with straps that are linked to the magnetic anchoring strap system;

FIG. 24 shows how a luggage basket is attached to the roof of the vehicle by metal straps that are linked to the magnetic anchoring strap system;

FIG. 25 shows how signage can be secured to the roof of the vehicle with metal straps that are attached to the magnetic anchoring strap system;

FIG. 26 shows how soft-filled bars are installed with straps that are attached to the magnetic anchoring strap system;

FIG. 27 shows how a rigid structure roof rack is attached to the magnetic anchoring strap system;

FIG. 28 shows how a ski rack is attached to the magnetic anchoring strap system; and

FIG. 29 shows how a bicycle rack is attached to the magnetic anchoring strap system.

### DETAILED DESCRIPTION OF THE INVENTION

The present invention will now be described in more detail with reference to the accompanying drawings, in which preferred embodiments of the invention are shown. However, this invention can be produced in many different ways and should not be limited to the embodiments set forth herein; rather, these embodiments are provided so that those skilled in the craft will fully understand this description.

An embodiment is an example or implementation of the invention. The various appearances of “an embodiment”, or “some embodiments” do not necessarily all refer to the same embodiments. Although various features of the invention may be described in the context of a single embodiment, the features may also be provided separately or in any suitable combination. Rather, while the invention may be described herein in the context of separate embodiments for clarity, the invention may also be implemented in a single embodiment.

Reference in the specification to “an embodiment”, or “some embodiments” or “other embodiments” means that a particular feature, structure or feature described in connection with the embodiments is included in at least one embodiment, but not necessarily in all embodiments of the inventions. It is understood that the phraseology and terminology used in this document should not be construed as limiting and have descriptive purposes only.

The methods of the present invention can be implemented by performing or completing these selected steps or tasks manually, automatically, or in combination. The term “method” refers to the ways, means, techniques, and procedures of performing a given task, including, but not limited to, ways, means, techniques, and procedures known or easily developed from the known ways, means, techniques and procedures, by practitioners of the craft to which the invention pertains to. The descriptions, examples, methods and materials presented in the claims and specifications are not to be construed as limiting but only as illustrative.

The meanings of technical and scientific terms used in this document are to be commonly understood as those to which the invention pertains, unless otherwise defined. The present invention can be implemented in tests or in practice with methods and materials equivalent or similar to those described herein.

The present invention will be fully understood from the following detailed description and accompanying drawings, which are provided by way of illustration and example only and are therefore not limiting of the present invention.

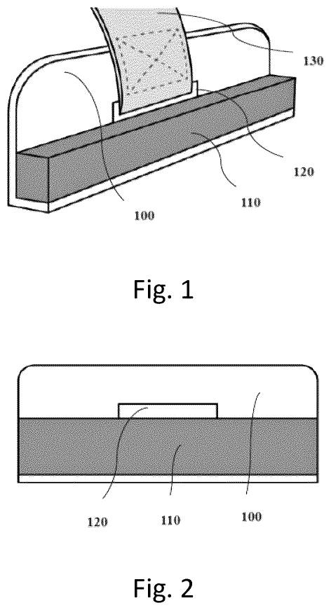

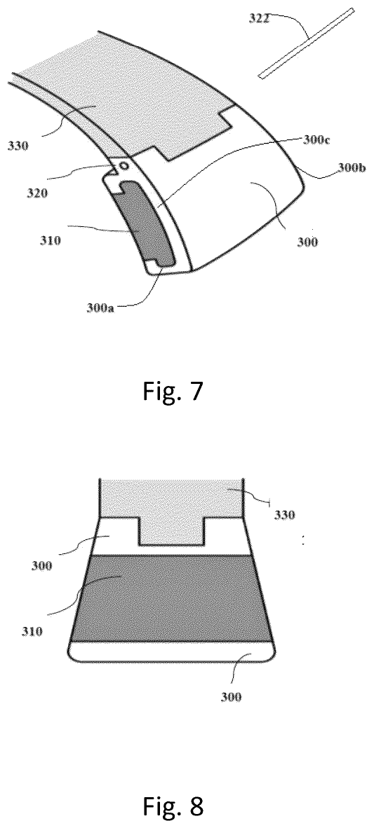

Reference is made to four embodiments of the magnetic anchoring strap system of the present invention: FIG. 1 shows a first embodiment of the magnetic anchoring strap system that comprises a magnet 110 (magnetic element), a mount 100 (metal structure), a strap 130 (fastening strap), and receiver 120 (slot to install the strap); FIG. 4 shows a second embodiment of the magnetic anchoring strap system that that comprises a magnet 210 (magnetic element), a mount 200 (metallic structure), a receiver 220 (fastening ring), and a strap 230 (plastic fastening anchorage); FIG. 7 is a third embodiment of the magnetic anchoring strap system that comprises a magnet 310 (magnetic element), a strap 330 (rubber or plastic belt), a mount 300 (rubber or plastic coating), a receiver 320, and a pin 322 (fastening bolt); and FIG. 10 is a fourth embodiment of the magnetic anchoring strap system that comprises a magnet 410 (magnetic element), a mount 400 (metallic structure), a receiver 420 (slot to install the strap), and a strap 430 (metal strap).

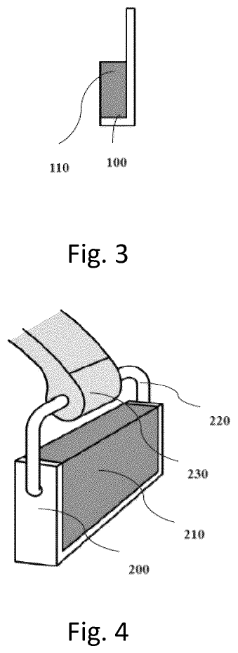

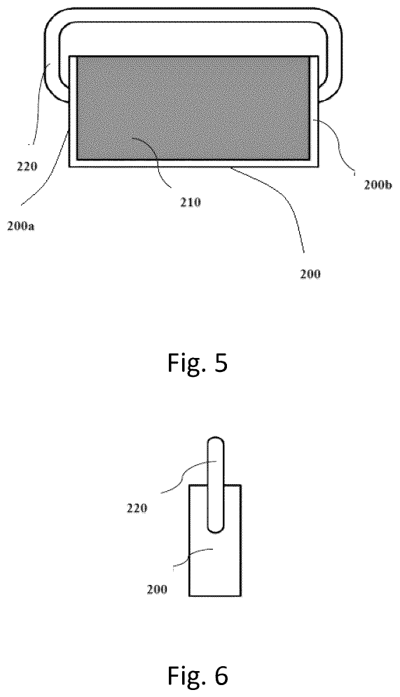

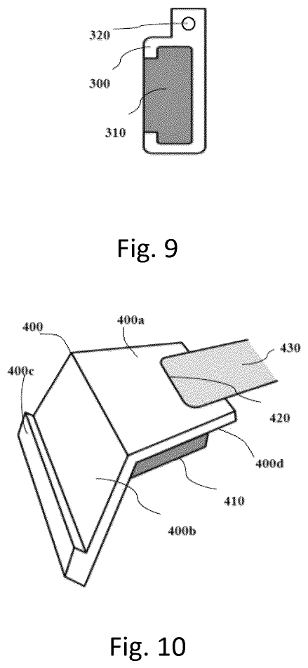

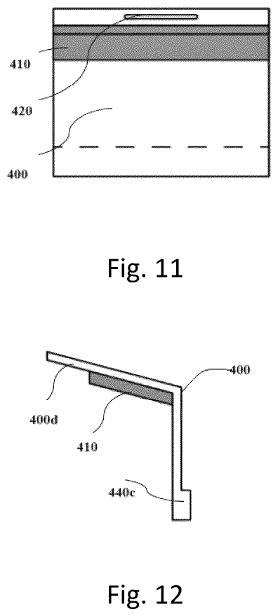

As seen in FIGS. 1-12, the present invention is a magnetic strap system that is used to secure an object that is placed on a roof of a vehicle.

The magnetic anchoring strap system comprises of at least two mounts 100, 200, 300, or 400 that are configured to be linearly placed between a pair of opposite doors of the vehicle and the body of the vehicle when the pair of opposite doors are closed, each mount 100, 200, 300, or 400 defines a receiver 120, 220, 320, or 420 that is configured to receive a strap 130, 230, 330, or 430. At least two magnets 110, 210, 310, or 410, each magnet 110, 210, 310, or 410 is fixedly attached to each mount 100, 200, 300, or 400, each magnet 110, 210, 310, or 410 is configured to keep each mount 100, 200, 300, or 400 on the body of the vehicle before the pair of opposite doors of the vehicle are closed. And, at least two straps 130, 230, 330, or 430, each strap 130, 230, 330, or 430 attaches to the receiver 120, 220, 320, or 420 of each mount 100, 200, 300, or 400, each strap 130, 230. 330, or 430 is configured to be used to secure the object that is placed on the roof of the vehicle.

In an embodiment of the present invention, the magnetic anchoring strap system that is used to secure the object that is placed on the roof of the vehicle further comprises of comprises of a vehicle rack 500, each strap 130, 230, 330, or 430 secures to the vehicle rack 500.

As seen in FIG. 1, in an embodiment of the present invention, each of the at least two mounts 100 is L-shaped and the receiver 120 is a rectangular aperture that is centrally positioned above each magnet 110.

As seen in FIG. 4, in an embodiment of the present invention, each of the at least two mounts 200 is a U-shaped mount, each magnet 210 is fixedly attached to each U-shaped mount 200, the receiver 220 is a U-shaped hooking bar that is attached to a left side 200a and a right side 200b of each U-shaped mount 200, and each strap 230 is secured to the U-shaped hooking bar 220.

As seen in FIG. 7, in an embodiment of the present invention, each of the at least two mounts 300 defines a t-cavity wherein each magnet 310 is secured, each magnet 310 is t-shaped, and the receiver 320 is a pin aperture that runs from a left section 300a of each mount to a right section 300b of each mount 300, the magnetic strap system further comprises of at least two pins 322, each pin 322 is configured to secure to each strap 330 and to each mount 300 after each pin 322 is placed within the pin aperture 320 of each mount 300.

As seen in FIG. 10, in an embodiment of the present invention, each of the at least two mounts 400 defines an upper side wall 400a that runs at an angle that is more than ninety degree From a vertical side wall 400b and each vertical side wall 400b defines a lower ledge 400c, each magnet 410 attaches to a bottom side 400d of each upper side wall 400a, and the receiver 420 is a rectangular aperture that is positioned at an outward section of each upper side wall 400a.

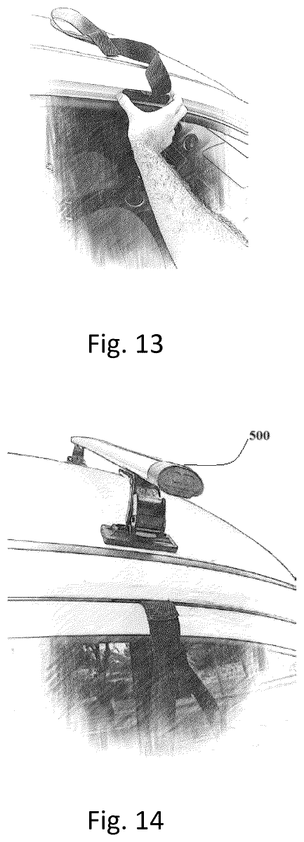

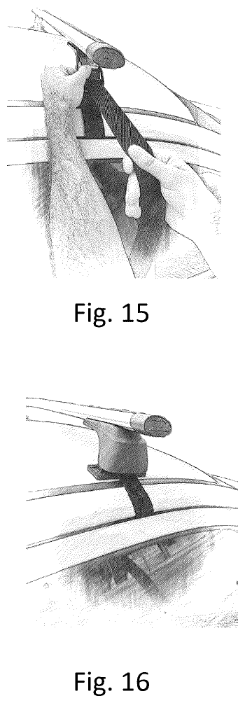

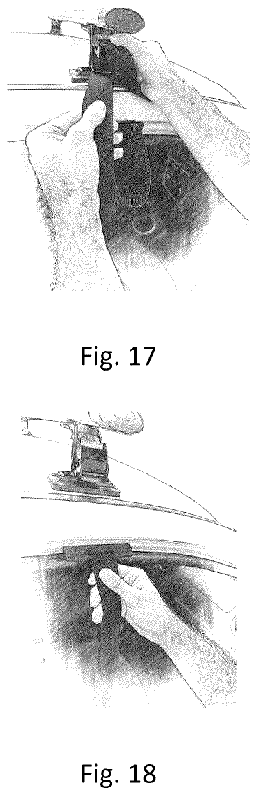

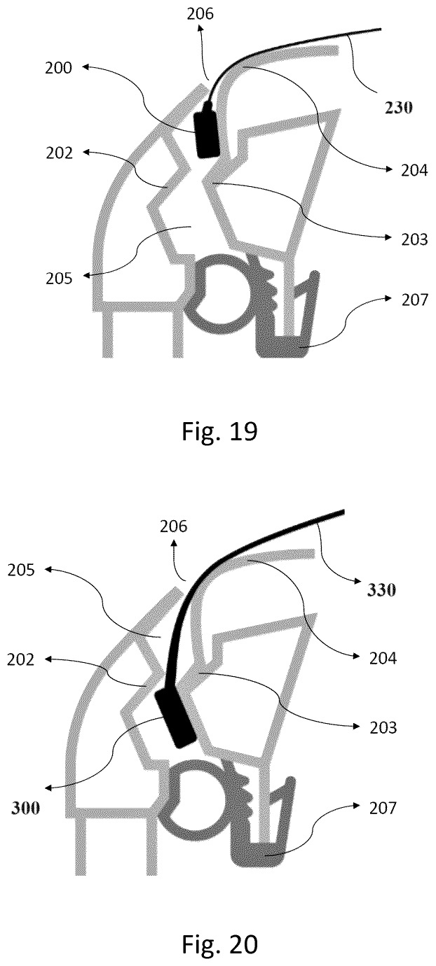

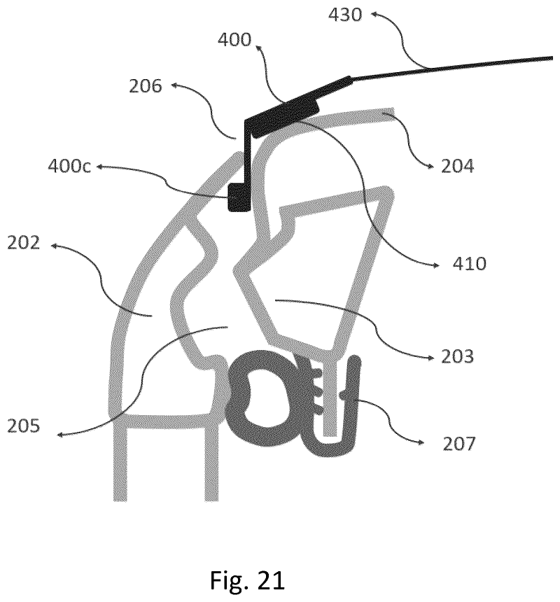

The magnetic anchoring strap system is extremely simple and practical to use. FIGS. 13-16 show how the magnetic anchoring strap system is installed on a vehicle. FIGS. 17-18 show how the magnetic anchoring strap system is removed from the vehicle.

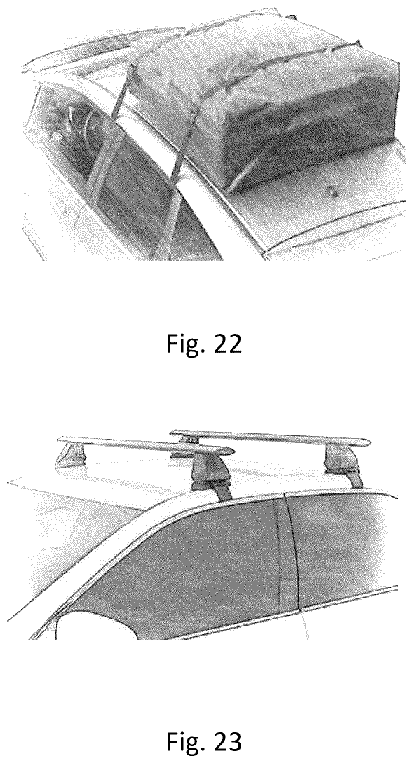

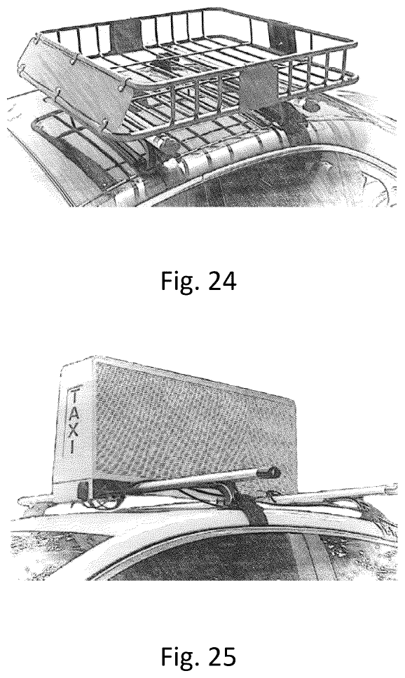

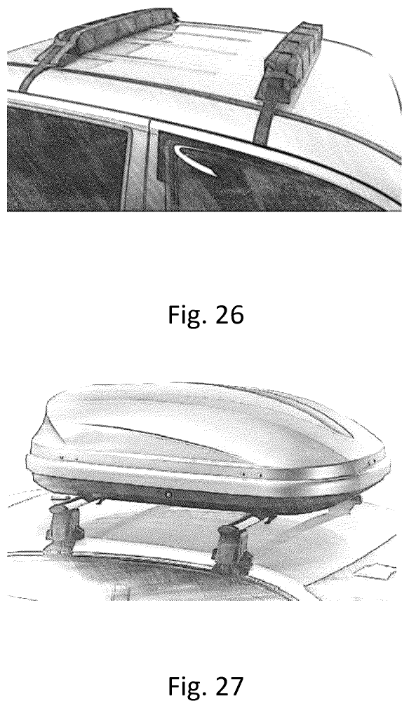

The possibilities offered by the magnetic anchoring strap system to secure luggage racks on the roof of vehicles, are very varied. FIG. 22 shows a roof bag attached to the door frame by straps linked to the magnetic anchoring strap system. FIG. 23 shows roof bars fastened with the straps linked to the magnetic anchorage. FIG. 24 shows a luggage basket attached to the roof of the vehicle by metal straps linked to the magnetic anchoring strap system. FIG. 25 shows a vehicle with signage used for vehicle identification or advertising purposes also secured to the roof of the vehicle with metal straps attached to the magnetic anchoring strap system. FIG. 26 shows soft-filled bars installed with straps attached to the magnetic anchoring strap system. FIG. 27 shows a rigid structure roof rack installed with metallic straps attached to the magnetic anchoring strap system.

The magnetic anchoring strap system can also be used to prevent accidents by strapping a piece of luggage or a roof rack to the magnetic anchoring strap system. When strapped, the piece of luggage or the roof rack will not eject into other vehicles if an accident occurs.

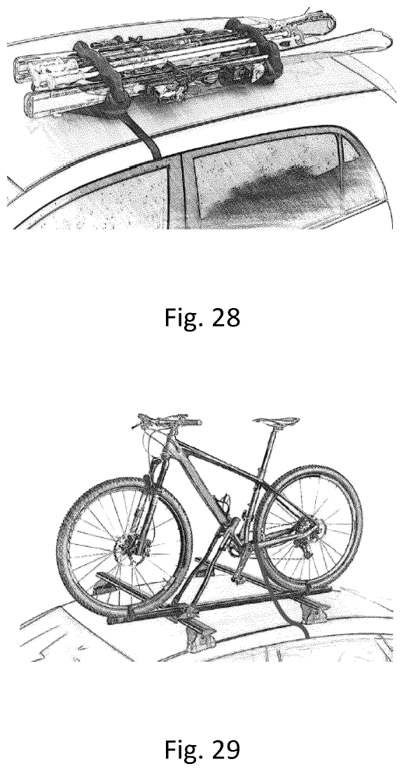

The magnetic anchoring strap systems is also used to prevent theft. FIGS. 28 and 29 show how the magnetic anchoring strap system is used to prevent the theft of a ski rack or a bicycle rack.

An advantage of the present invention is that it provides a magnetic anchoring strap system that allows a luggage rack to be secured to a vehicle roof.

Another advantage of the present invention is that it provides a magnetic anchoring strap system that prevents accidents and theft.

Yet another advantage of the present invention is that it provides a magnetic anchoring strap system that will not interfere with the closing of the vehicle doors when used.

Therefore, the invention has been described in terms of embodiments and examples, but it will be obvious that these may vary in many other ways. Such variations are not to be considered as a departure from the spirit and scope of the invention, and all modifications that would be obvious to a person skilled in the craft are intended to be included within the scope of the invention as represented in the claims below.

What is claimed is:

1. An anchor for the door frame of a vehicle that, joined by at least one strap, allows loads or roof racks to be fasten to the roof of a vehicle, which is characterized by having at least one magnet so that it is magnetically hold to the door frame.

2. The magnetic anchor according to claim 1 is characterized by adhering to the upper and inner door frame of the body.

3. The magnetic anchor according to claim 2 is characterized by having dimensions consistent with the gap generated between the body frame and the door frame, to allow the door to close without difficulty.

4. The magnetic anchor according to claim 1 is characterized by adhering to the roof of the door frame of the body.

5. The magnetic anchor according to claim 4 is characterized by having another piece attached that is located in the gap of the door frame of the body, being trapped between the two frames, when the door is closed.

6. The magnetic anchor according to claim 1 is characterized by having dimensions consistent with the gap generated between the body frame and the door frame, to allow the door to close without difficulty.

7. The magnetic anchor according to claim 1 is characterized by having another piece attached that is located in the gap of the door frame of the body, being trapped between the two frames, when the door is closed.

8. The magnetic anchor of claim 1 has the characteristic that the magnet is attached to a structure to hold one or more straps.

9. The magnetic anchor of claim 1 has the characteristic that the magnet is attached to the strap by its wrapper, without the need for a structure.

10. The magnetic anchor according to claim 1 has the characteristic of having at least one hole for attaching at least one strap.

11. The magnetic anchor according to claim 1 has the characteristic of having at least one ring to attach at least one strap.

12. The magnetic anchor according to claim 1 has the characteristic of requiring at least one unit to fasten loads to the roof of the vehicle.

13. The magnetic anchor according to claim 1 has the characteristic of requiring at least two units to install roof racks on the roof of the vehicle, which are installed linearly between two opposite doors of the vehicle.

14. A magnetic anchoring strap system that is used to secure an object that is placed on a roof of a vehicle, the magnetic anchoring strap system comprises:
at least two mounts that are configured to be linearly placed between a pair of opposite doors of the vehicle and the body of the vehicle when the pair of opposite doors are closed, each mount defines a receiver that is configured to receive a strap;
At least two magnets, each magnet is fixedly attached to each mount, each magnet is configured to keep each mount on the body of the vehicle before the pair of opposite doors of the vehicle are closed; and
At least two straps, each strap attaches to the receiver of each mount, each strap is configured to be used to secure the object that is placed on the roof of the vehicle.

15. The magnetic anchoring strap system that is used to secure the object that is placed on the roof of the vehicle of claim 14, the magnetic anchoring strap system comprises of a vehicle rack, each strap secures to the vehicle rack.

16. The magnetic anchoring strap system that is used to secure the object that is placed on the roof of the vehicle of claim 15, wherein each of the at least two mounts is L-shaped and the receiver is a rectangular aperture that is centrally positioned above each magnet.

17. The magnetic anchoring strap system that is used to secure the object that is placed on the roof of the vehicle of claim 15, wherein each of the at least two mounts is a U-shaped mount, each magnet is fixedly attached to each U-shaped mount, the receiver is a U-shaped hooking bar that is attached to a left side and a right side of each U-shaped mount, and each strap is secured to the U-shaped hooking bar.

18. The magnetic anchoring strap system that is used to secure the object that is placed on the roof of the vehicle of claim 15, wherein each of the at least two mounts defines a t-cavity wherein each magnet is secured, each magnet is t-shaped, and the receiver is a pin aperture that runs from a left section of each mount to a right section of each mount, the magnetic strap system further comprises of at least two pins, each pin is configured to secure to each strap to each mount after each pin is placed within the pin aperture of each mount.

19. The magnetic anchoring strap system that is used to secure the object that is placed on the roof of the vehicle of claim 15, wherein each of the at least two mounts defines an upper side wall that runs at an angle that is more than ninety degree from a vertical side wall and each vertical side wall defines a lower ledge, each magnet attaches to a bottom side of each upper side wall, and the receiver is a rectangular aperture that is positioned at an outward section of each upper side wall.

20. The magnetic anchoring strap system that is used to secure the object that is placed on the roof of the vehicle of claim 14, wherein each of the at least two mounts is an L-shaped mount and wherein the receiver is a rectangular aperture that is centrally positioned above each magnet.
